(19) United States
(12) Patent Application Publication
(10) Pub. No.: US 2016/0167825 A1
(43) Pub. Date: Jun. 16, 2016

(54) PLASTIC CONTAINER AND BLOW MOULD FOR THE PRODUCTION THEREOF

(71) Applicant: KRONES AG, Neutraubling (DE)

(72) Inventors: Alexander DACHS, Neutraubling (DE); Peter KNAPP, Neutraubling (DE); Stephanie PIETRASCH, Neutraubling (DE); Ulrich ERFINDER, Neutraubling (DE)

(21) Appl. No.: 14/651,464

(22) PCT Filed: Mar. 28, 2014
(86) PCT No.: PCT/EP2014/056276

§ 371 Date: Jun. 11, 2015

(30) Foreign Application Priority Data
Apr. 15, 2013 (DE) 10 2013 103 777.1

(51) Int. Cl. B65D 1/02; B29C 49/48

(52) U.S. Cl. CPC B65D 1/0284; B29C 49/48; B29C 2049/4882; B29L 2031/7158

(57) ABSTRACT

A plastics material container, in particular for beverages, with an aperture by way of which a liquid is capable of being removed from the container, with a main body adjoining this aperture in a longitudinal direction and a base portion adjoining this main body in this longitudinal direction, wherein the base portion has at least three stand feet, wherein external surfaces of these stand feet in each case form a stand portion of the plastics material container extending in sections in the form of an annular segment over a pre-set circumferential angle and wherein at least three grooves are formed between these stand feet, wherein these grooves extend at least also in a radial direction of the plastics material container which is at a right angle to the longitudinal direction, wherein these grooves have in each case a groove bottom which extends at least also in the radial direction as well as a wall portion which extends at least also from this groove bottom to a stand portion of a stand foot adjacent to this groove bottom.

### CROSS-REFERENCE TO RELATED APPLICATIONS

This application claims priority to PCT Application No. PCT/EP2014/056276, having a filing date of Mar. 28, 2014, based on DE 10 2013 103 777.1, having a filing date of Apr. 15, 2013, the entire contents of which are hereby incorporated by reference.

### FIELD OF TECHNOLOGY

The following relates to a plastics material container, and in particular to a plastics material container for receiving liquids and in particular beverages. Plastics material containers of this type have long been known from the prior art. In this case these containers have recently been called upon to an increasing degree to solve the task of reducing the material expenditure and, at the same time, however, of maintaining stability of the container. This relates for example to stability with respect to internal pressures caused by the filled product, but also with respect to external stresses which can arise for example as a result of stacking the containers.

### BACKGROUND

In the design of containers of this type the base of these containers is particularly critical since it serves as a stand face on the one hand and is also subjected in a special way to the pressures by the liquid on the other hand. Different designs of the base are known. Embodiments of the invention relate, in particular, to a container which is suitable for the hot filling of beverages, for example for filling with iced tea. As a rule, such containers suitable for hot filling have several feet, in particular a six-footed base design of different diameters and base heights. On marketing grounds, however, customers usually want a low base design, similar to that of a so-called still water base. In the case of hot-filled containers, however, the realisation is very difficult in this case or is associated with drawbacks respectively, such as for example an increased weight of the plastics material pre-forms from which the containers are produced.

### SUMMARY

An aspect relates to a container, or in particular, a container base respectively, which allows a reduced base height even for relatively high loads, in particular as a result of pressures in the interior of the container. In addition, this base design should preferably be suitable for filling processes with hot or warm filling charges under internal pressure.

A plastics material container according to embodiments of the invention, in particular for beverages, has an aperture by way of which a liquid is capable of being removed from (and/or supplied to) the container. In addition, the container has a main body adjoining this aperture in a longitudinal direction as well as a base portion adjoining this main body in this longitudinal direction. In this case the base portion has at least three stand feet, in which case external surfaces of these stand feet in each case form a stand portion of the plastics material container extending in sections in the form of an annular segment over a pre-set circumferential angle. In addition, at least three grooves are formed in each case between these stand feet, wherein it is preferable for these grooves and the stand feet to alternate in the circumferential direction of the container. In addition, these grooves extend at least also in a radial direction of the plastics material container which is at a right angle to the longitudinal direction, wherein these grooves having in each case a groove bottom which extends at least also in the radial direction as well as a wall portion which extends (at least also) from this groove bottom to the stand portion of a stand foot adjacent to this groove bottom. According to embodiments of the invention, the sum of the (i.e. in particular all the) above-mentioned circumferential angles of the respective stand portions is greater than 180°.

Although it is also usual for stand feet frequently to be provided in the case of known containers, however, they form a rather selective stand face of the container. Within the scope of embodiments of the present invention it is now proposed that this circumferential angle should be made very large, i.e. at least in such a way that along a circle the actual stand face occupies more than half of this circle.

It is preferable for an angle width of the stand face to result from the opening angle of the cut or the groove respectively and the number of the cuts or the grooves respectively which is used. This stand face is thus preferably an interrupted complete circle. In sum the segments of the stand face occupy more than 50% of the complete circle.

In this way, a stand face in the form of an annular segment, i.e. in particular a stand face in the form of a ring interrupted in sections is preferable. These respective interruptions derive in this case from the grooves mentioned. As will be explained in greater detail below, however, the grooves are kept very narrow and, in this way, the stand face or the stand portion respectively is interrupted relatively slightly as compared with containers known from the prior art.

It is advantageous for a sum of these circumferential angles to be greater than 200°, preferably greater than 220°, preferably greater than 240°, preferably greater than 270° and preferably greater than 300°. This means that the feet form a stand face which is largely predominant with respect to a complete circle.

It is advantageous in this case for the individual stand portions to be equal in size and arranged adjacent to one another in the circumferential direction. In this case, as mentioned above, these stand portions are interrupted by the grooves in each case.

In the case of a further advantageous embodiment all the grooves are made substantially identical with respect to their geometrical structure. In other words it is preferable for only one type of groove to be provided. It would also be possible, however, in addition to the aforesaid first grooves, for second grooves to be capable of being provided which alternate for example in each case with the first grooves named above.

It is advantageous, as mentioned above, for the container to be a hot-fill container, i.e. a container which is intended and envisaged for filling with a heated medium. In general, however, the container design described here is preferably suitable for products filled hot with an internal pressure of up to 4.0 bar, for products filled hot and cold without pressure and also for products filled cold with an internal pressure of up to 6.0 bar. Furthermore, the container is advantageously a PET container with a filling volume of from 100 ml to 5.0 1. In addition, it would be possible for nitrogen, which checks the heavily drop in pressure in the following cooling process, to be supplied to the container or the head space of the container respectively after the filling with the hot medium and before the closure, in order to ensure a stable pressure in the container.

In the case of a further advantageous embodiment a cross-section of the aperture is smaller than a cross-section of the main body. Furthermore, it is preferable for the main body to have a circular cross-section. In the case of a further advantageous embodiment the base portion also has a circular cross-section. In the case of a further advantageous embodiment the groove bottom has a curved profile or a profile curved at least in sections respectively in a projection in a radial direction of the container. It is advantageous in this case for a radius of curvature of this groove bottom to be more than 5 mm, preferably more than 10 mm, preferably more than 20 mm. In addition it would be possible for the aforesaid groove bottom also to extend in a straight line at least in sections.

In the case of a further advantageous embodiment the groove bottom has a width in a circumferential direction which is between 0.1 mm and 10 mm, preferably between 1 mm and 8 mm and in a particularly preferred manner between 1 mm and 6 mm. It is preferable for the maximum width of this groove bottom to amount to a third of the external diameter of the container.

In addition, the groove bottom has a constant width in this case. It would also be possible, however, for the groove bottom to be enlarged outwards, in which case the edges of this groove bottom preferably extend in a straight line.

In the case of a further advantageous embodiment a ratio between the width of the groove bottom and a distance of two stand portions bounding this groove bottom is between 1:1 and 1:10, preferably between 1:1.1 and 1:8, preferably between 1:1.5 and 1:6.

It also becomes clear from this ratio that the grooves are made very narrow as compared with grooves known from the prior art, as a result of which the stability of the container is increased.

In the case of a further advantageous embodiment the container has an external thread.

In the case of a further advantageous embodiment the aforesaid groove bottom extends in a straight line at least in sections in a circumferential direction of the container. In contrast to this, the known containers usually have curved shapes of these groove bottoms.

In the case of a further advantageous embodiment the base contour on the inside or the contour in the region of the groove bottom starting from a centre of the base respectively is described by several portions following in succession with curvatures which are different at least in part. In this way for example, the first portion starting from the mid-point of the base portion can be a straight line. This straight line can be followed by a first curved portion with a pre-set radius (of curvature). It would also be possible, however, for the groove or the groove bottom respectively not to extend into the centre of the container base, i.e. as far as the injection point.

This first curved portion can be followed by a second curved portion with a further radius (of curvature) and this second curved portion can be followed by a third curved portion with a third (final) radius (of curvature). This geometry can form the guiding contour for the internal cross-sectional contour in this case and preferably indicate the course of the cut or the groove respectively.

As variants the named (constant) radii (of curvature), or curved portions which follow the straight-line portion respectively, can also be replaced by a common spline of the nth degree. Alternatively, one of the curved portions could also be represented by a straight line. In the case of a variant with a spline, the latter merges with a constant curvature, at least with a constant tangent, into a straight line which is parallel to the external diameter.

It is advantageous for the transitions of the radii or of the curved portions respectively to have in part, and preferably all, a constant tangent. The transitions of the splines are preferably with a constant curvature, but at least with a constant tangent.

The function of this contour is that the compressive forces acting upon the centre of the base are diverted by these “cuts” into the lateral wall of the bottle. It is therefore advantageous for the starting point of the guiding contour in the middle of the container to be lower than the end point of the guiding contour.

In the case of a further advantageous embodiment at least one groove starting from the groove bottom has an opening angle which is less than 45°, preferably less than 30°, preferably less than 25°, and in a particularly preferred manner less than 20°. In contrast to known containers, very narrow grooves are thus proposed. On account of these narrow grooves, as mentioned above, the stand face of the container can be enlarged and at the same time a relatively flat base design can be made possible. In this case this angle is preferably formed between the groove bottom on the one hand and the ends—reaching the groove—of the two stand portions or feet respectively adjacent to this groove.

In the case of a further advantageous embodiment the stand portions in the form of an annular segment span a stand plane of the container which is at a right angle to the longitudinal direction of the container. This means that although the stand face itself is preferably annular or in the shape of an annular segment respectively, however, a plane passing through them extends at a right angle to the longitudinal axis of the container.

In the case of a further advantageous embodiment at least one wall portion extends at least in sections at an angle which is more than 45°, preferably more than 60°, preferably more than 75°, with respect to the stand plane. It is also evident from this that the container has very steeply extending wall portions in a standing state.

In the case of a further advantageous embodiment the container has between three and twelve stand feet, preferably between four and eight stand feet, and in a particularly preferred manner between four and seven stand feet.

In other words, it would be possible to define cut segments, wherein a cut segment being formed from a through cut or the groove respectively and from a part of the outer face of the container. The base can advantageously contain a number of a minimum of 3 cut segments up to a maximum of 12 cut segments on the circumference.

The external dimensions of the base are advantageously fixed by the external diameter and the height of the base. The dimension of the diameter of the stand circle can be fixed by a ratio to the external diameter of the container. It is advantageous for a ratio between an external diameter of the plastics material container and a diameter of the stand circle to be between 0.5 and 0.99, preferably between 0.5 and 0.9, and in a particularly preferred manner between 0.6 and 0.8.

In the case of a further advantageous embodiment at least one wall portion, or partial wall portion respectively, of a groove extends in a straight line at least in sections in at least one pre-set direction. In particular, this wall portion extends in a straight line in a direction which also has at least one component in the longitudinal direction of the container. In this way, in particular, such a wall portion can be defined as being between a specified point of the groove, which is at a specified radial distance from the longitudinal direction, to a specified point of the stand foot, which is at the same radial distance from the longitudinal direction of the container.

Previously these wall portions are usually made curved. On account of the straight design, however, it is possible to increase the stability of the base. A shape in a substantially straight line is understood in this case as being that the radius of curvature of this wall portion is more than 4 cm, preferably more than 8 cm, preferably more than 10 cm and preferably more than 20 cm.

In the case of a further advantageous embodiment this wall portion extends in a straight line at least in sections in two pre-set directions at a right angle to each other. In this way, this wall portion advantageous forms a flat face.

It is advantageous for the base portion to have, at least in sections, a first dome-like structure extending in the direction of a centre of the base portion. This dome-like structure is directed in this case towards an internal volume of the container. This means that when a container is standing upright a centre of the base portion is at a distance from a stand face. In addition, it would also be possible, however, for the container to have a second dome-like structure in which an injection point of the container is situated.

In the case of a further advantageous embodiment the centre of the base portion is arranged lower in the longitudinal direction of the plastics material container than a pre-set further region of the base portion and, in particular, than a region in which this base portion merges into the main body.

On account of this arrangement, with little material the container can withstand relatively high internal pressures. As a result, the compressive forces are converted into tensile forces. In this way, lighter containers can in turn be made available with correspondingly less material. The term “lower” is in turn understood in this case to refer to a container standing upright.

In the case of a further advantageous embodiment the base portion has an injection point in its centre and at least one groove bottom extends as far as this injection point or is at a distance of less than 5 mm from this injection point. In other words, in this case the grooves are preferably brought very close to the injection point or to a region surrounding the injection point respectively.

In the case of a further advantageous embodiment at least one groove also extends in a circumferential portion of the base portion. A circumferential portion is understood in this case as being, in particular, that region which, when the container is placed on a stand face, is visible from the side, or in general that portion which is visible in a radial direction extending at a right angle to the longitudinal direction respectively.

Embodiments of the present invention further relates to a blow mould for producing a plastics material container, wherein the blow mould forms a cavity inside which a plastics material pre-form is capable of being expanded against an inner wall of the blow mould by being acted upon with a flowable medium. According to embodiments of the invention the blow mould has a base element which is suitable for producing a base portion of the type described above.

### BRIEF DESCRIPTION

Some of the embodiments will be described in detail, with reference to the following figures, wherein like designations denote like members, wherein:

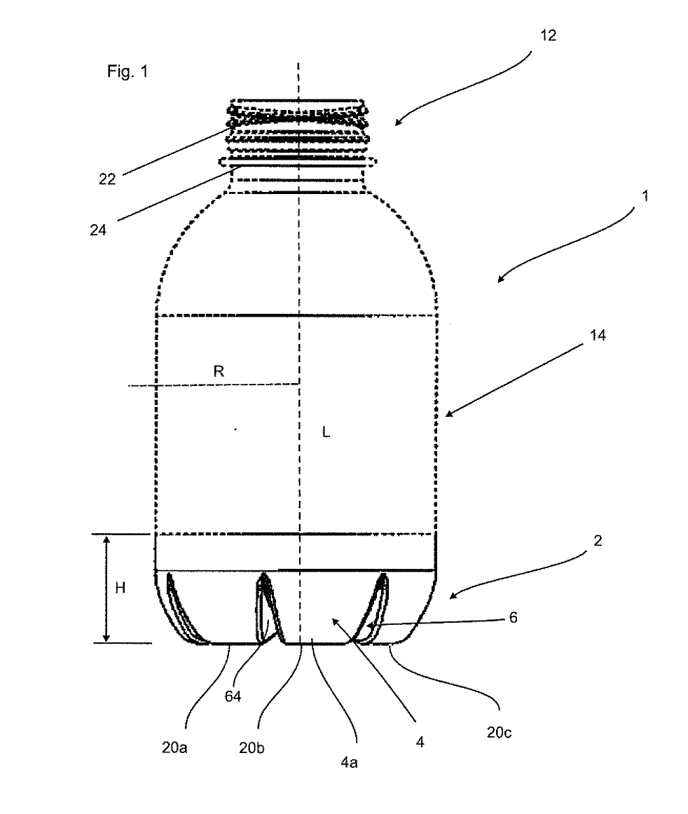

FIG. 1 is an illustration of a container according to embodiments of the invention;

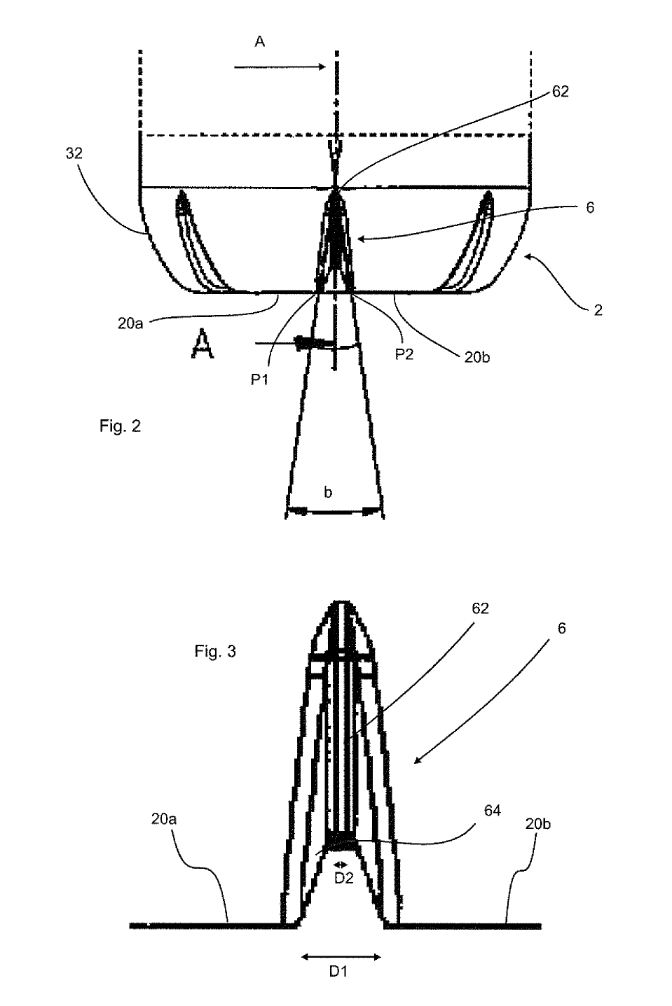

FIG. 2 is a detailed view of the base portion of the container shown in FIG. 1;

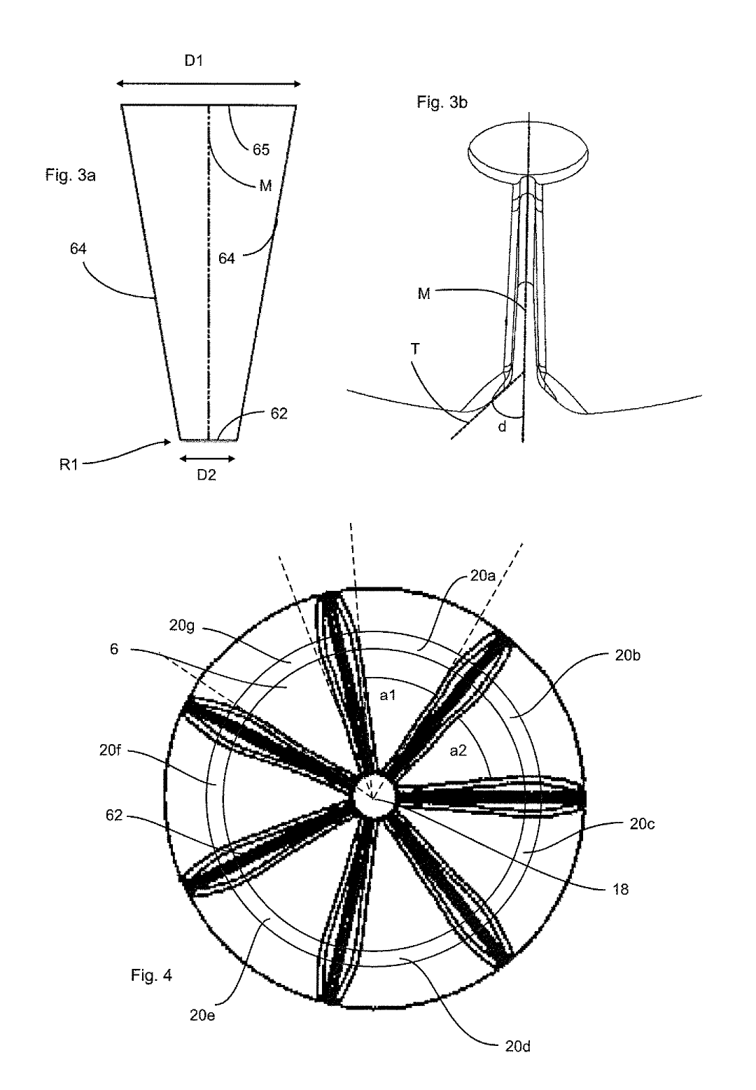

FIG. 3 is an illustration of a groove of the base portion;

FIG. 3a is an illustration of a wall of the container in the region of a groove;

FIG. 3b is a further detailed illustration of a groove;

FIG. 4 is a top view of the base portion from below;

FIG. 5 is an illustration to explain the stand faces;

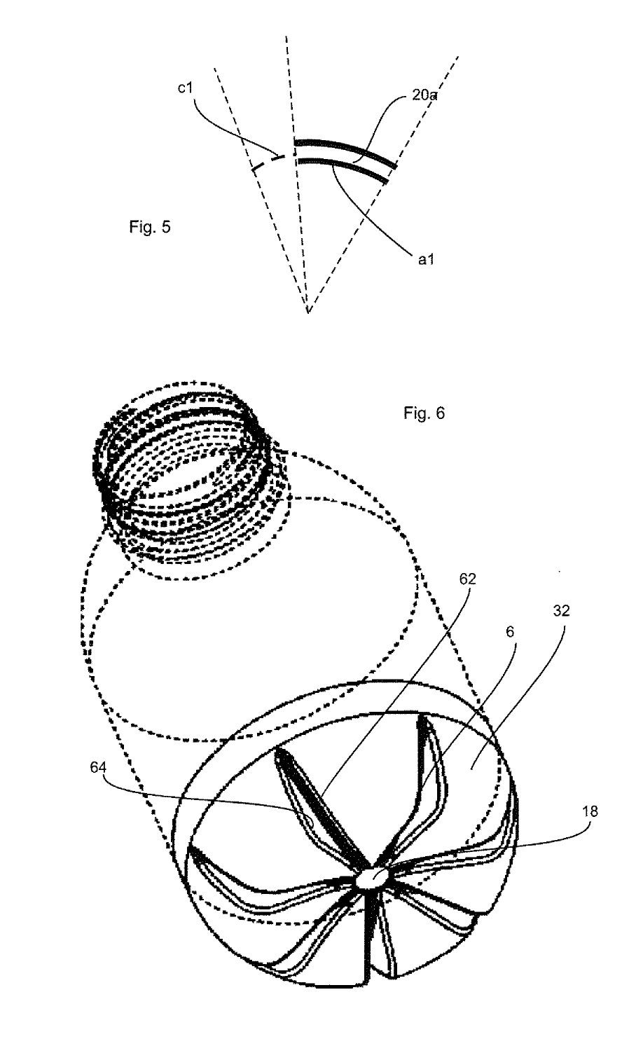

FIG. 6 is a further perspective illustration of a container;

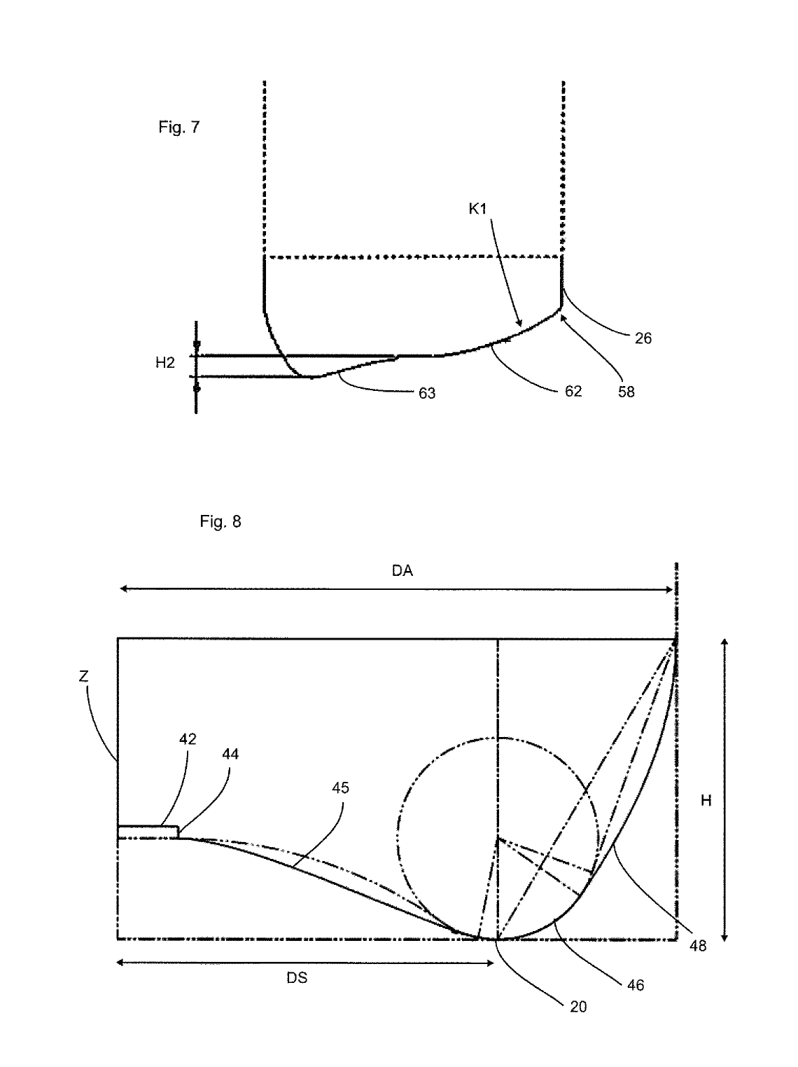

FIG. 7 shows a comparison of a groove bottom and a stand foot;

FIG. 8 is an illustration of an external surface of the container in the region of a stand foot;

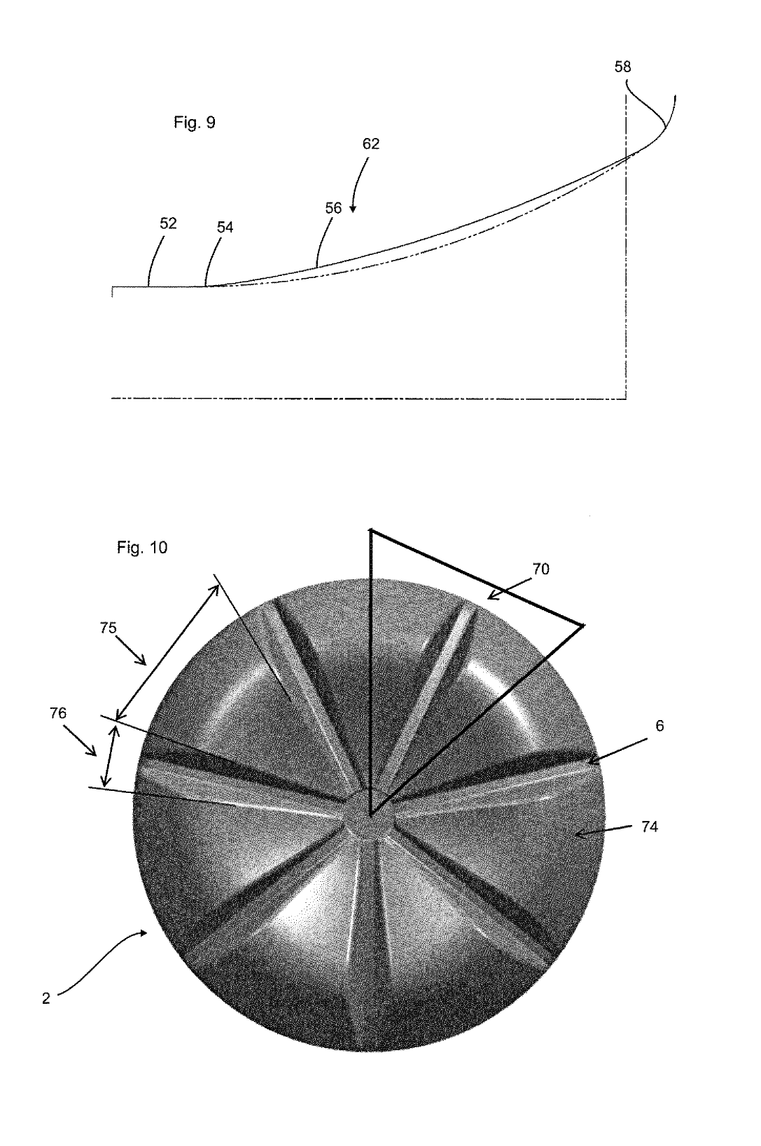

FIG. 9 is a cross-sectional illustration of a groove; and

FIG. 10 is an illustration of the base portion.

### DETAILED DESCRIPTION

FIG. 1 is a side view of a container 1 according to embodiments of the invention. This container has an aperture portion 12 which is followed by a main body 14 in a longitudinal direction L of the container 1. This main body 14 forms in this case the essential receiving volume for receiving a liquid. This main body 14 is followed in turn by a base portion 2. The reference sign R designates a radial direction of the container. In this case, as mentioned above, the container 1 preferably has a thread 22 as well as a support ring 24 situated below this thread.

The base portion 2 has in this case several grooves 6. It is already evident from FIG. 1 that these grooves are cut in substantially more deeply than grooves known from the prior art. In this case these grooves 6 have a wall portion 64 in each case which extends from a groove bottom (not shown) to the stand feet 4. The reference sign 4a refers to an external wall of these stand feet 4 which at the same time form stand portions 20a, 20b and 20c. The further stand portions are not visible in FIG. 1.

The reference sign H designates a height of the base which is designed so as to be variable in this case. It is evident, however, that the height H of the base is relatively low as compared with base heights (in particular of containers capable of being filled hot) known from the prior art.

FIG. 2 is a detailed illustration of a base portion 2. The groove 6 and the groove bottom 62, in particular, are evident here. The groove 6 is made symmetrical in this case with respect to this groove bottom 62. The reference sign b designates an opening angle of the groove 6 which, as mentioned above, is defined between the groove bottom and the ends of the stand portions 20a and 20b which extend to the groove 6. These two points defining the angle with respect to the groove bottom are provided in this case with the reference signs P1 and P2. In this case it is possible for no sharp angles or corners to be present at the points P1 and P2, but for these to be made curved and/or trimmed off.

The reference sign 32 designates a circumferential region of the base portion 2, wherein it is evident that the grooves 6 also extend in this circumferential region 32.

FIG. 3 is a detailed illustration of a groove 6. The groove bottom 62 and the wall portion 64 following the groove bottom are again evident in this case. This wall portion 64, as mentioned above, forms a flat face here. In addition, a distance between the two stand faces 20a and 20b is indicated with the reference sign D1 and a width of the groove bottom 62 with the reference sign D2. A ratio between these two lengths is preferably less than 10:1, preferably less than 8:1, and in a particularly preferred manner less than 5:1.

FIG. 3a is a cross-sectional illustration of the container as viewed in the region of a groove and in the radial direction of the container. The cross-sectional contour of the cut or the groove respectively is described by two parallel straight lines, namely on the one hand the groove bottom 62 and on the other hand the geometrical distance 65 between two stand portions on the one hand and two straight lines which are symmetrical to the centre line M and which are formed by the wall portions 64.

The straight lines formed by the wall portions 64 can also be replaced as variants of the cross-sectional contour by two symmetrical radii or splines. In this case the wall portions extend not in straight lines but in curves. The straight lines or the wall portions 64 respectively are controlled by way of a ratio which results from the length of the groove bottom 62 and the distance 65. As mentioned above, the distance 65 (D2) is at least equal to, but preferably larger than, the length D2 of the groove bottom shown in FIG. 3a.

It is also preferable for the length of the portion 64 to be larger than the length D2. It is preferable for the ratio of the length of the straight line or of the portion respectively to be between 8 times and 12 times, preferably between 9 times and 11 times, and in a particularly preferred manner approximately 10 times, the distance D2.

FIG. 3b is a further detailed illustration of a groove 6. It is evident in this case that the groove is flattened or trimmed respectively at the points P1, P2 shown in FIG. 2. In this case the reference sign T designates a tangent which touches this flattened or trimmed region. An angle d between this tangent T and the centre line M is in this case between 0° and 89°, preferably between 10° and 80°, preferably between 20° and 70°, and in a particularly preferred manner between 30° and 60°. In addition, it is evident that the region can again be made curved at these points P1 and P2.

FIG. 4 is a view of the base portion 2 from below. An injection point 18 is present in the centre of the base portion in this case.

In addition, the individual stand portions 20a, 20b, 20c, 20d, 20e, 20f and 20g are illustrated here. These form angles a1, a2 . . . , in each case in the circumferential direction. The individual circumferential angles in this case are of equal size in each case. The grooves are situated between these stand portions, and thus do not form stand faces.

FIG. 5 is an illustration of the stand faces. In this case the stand portion 20a again forms a stand face which has a circumferential angle a1. The circumferential angle c1 refers to the angle formed by the groove, i.e. a stand face of the container is not formed in this portion. These angles are in a ratio in this case which is between 1:1 and 10:1, preferably between 1.5:1 and 1:8, and in a particularly preferred manner between 1:2 and 1:6. This ratio in turn is also decisive for the proportion of the stand portions on a complete circle, since, as mentioned above, the individual stand feet are preferably designed in the same manner and also the grooves formed between the stand feet.

FIG. 6 is a perspective illustration of a container according to embodiments of the invention. In this case too, the seven stand feet are again evident and also the grooves 6 arranged between them. It is also evident that the individual grooves extend as far as the injection point 18 or the region thereof respectively.

FIG. 7 is a view along the line AA in FIG. 2. In this case the course in the groove bottom 62 is illustrated on the right-hand side and the course in the region of a stand foot which leads to a stand portion is illustrated on the left-hand side. The reference sign H2 designates a difference in height between this stand face 63 and a height level of the injection point. This height, which at the same time is also a measure of the freedom of the base, can be selected to be variable in this case and is between 1 mm and 20 mm, preferably between 2 mm and 18 mm, preferably between 3 mm and 15 mm, and preferably between 4 mm and 10 mm.

It is further evident that the groove bottom 62 is only slightly curved, and in other words has very high radii of curvature. In a transition between the groove bottom 62 and a circumferential wall, however, there are relatively small radii of curvature (R1/FIG. 3a) which are preferably between a radius of 0.001 mm and a radius of 15 mm, preferably between a radius of 0.1 mm and a radius of 10 mm, preferably between a radius of 0.2 mm and a radius of 5 mm. In this case it would be possible for it to be a constant radius of curvature. It would also be possible, however, for this radius of curvature to vary. In this way, the radius of curvature could decrease or increase from radially on the inside to radially on the outside. In addition, it would be possible for the radius of curvature first to increase and then to decrease again or, in reverse, first to decrease and then to increase again. By way of example, the radius of curvature could vary between 0.1 mm and 10 mm, in which case it is preferable for a change of this type to take place in a continuous manner. The reference sign K1 refers to a radius of curvature of the groove bottom 62.

FIG. 8 shows an external surface of the container 1 or the base contour on the outside respectively. This is described in this case, starting from a centre of the base portion, by a substantially horizontal straight line 42 (first portion), wherein “substantially horizontal” is understood as being that an angle of inclination of this straight line deviates from a precisely horizontal direction by an amount of not more than 10°, preferably by not more than 7°, preferably by not more than 5°, in a particularly preferred manner by not more than 3°, and in a particularly preferred manner by not more than 1°. As well as a straight line, slight curves are also possible in this case, for example curves with a radius of curvature of more than 10 cm, preferably of more than 20 cm.

This horizontal straight line 42 or the first horizontal portion 42 respectively is followed by a second portion 44. An angle of this second portion 44 is between 0° and 45° with respect to the axis of rotation Z (10, FIG. 1). This second portion 44 is followed by a curved portion or a spline 45 respectively. A course of the radius of curvature of this curved portion can be described by a polynomial of the nth degree (in which n is preferably between 3 and 8). This curved portion 45 also forms the dome-like structure of the container base 2. The reference sign DA designates an external diameter of the container 1 or the base portion thereof respectively, and the reference sign DS designates a stand “circle” diameter, i.e. the diameter or radius respectively which would be occupied by a stand face enlarged to a complete circle. This curved portion 45 is followed by the stand portion 20. This stand portion 20 also extends preferably horizontally in this case in the radial direction of the base, so as to result in an annular stand face. This stand portion 20 in turn is followed by a curved portion or spline 46 respectively and the latter is followed by a further curved portion 48. The so-called external face of the base geometry is formed from this contour by a rotation about the axis of rotation Z. This axis of rotation also determines the longitudinal direction of the container.

The transitions of the radii or the straight portions respectively are preferably at least in part and in a particularly preferred manner all with a constant tangent. The transitions of the curved portions 45, 46, 48 or splines respectively are preferably with a constant curvature, but in a particularly preferred manner at least with a constant tangent.

The curved portions 45, 46, 48 can also be replaced as variants of the external geometry at least in part by the geometry of a straight line or a (constant) radius. The course of curvature of the spline 45, 46, 48 can, as mentioned above, be described by a polynomial of the nth degree.

FIG. 9 is an illustration of the course of curvature in a region of a groove bottom or the base contour on the inside respectively. In this case, as viewed starting from the centre of the base (on the left in the figure), a portion 52 extending in a straight line is first provided, which preferably likewise extends in a substantially horizontal direction, wherein “substantially horizontal” being understood as being that an angle of inclination of this straight line deviates from a precisely horizontal direction by an amount of not more than 10°, preferably by not more than 7°, preferably by not more than 5°, in a particularly preferred manner by not more than 3°, and in a particularly preferred manner by not more than 1°.

This portion extending in a straight line is followed by a first curved portion 54 and a second curved portion 56. These two curved portions 54 and 56 together form the groove bottom 62. The curved portion 56 is followed by a further curved portion 58.

FIG. 10 is a further perspective illustration of the container base 2 in order to explain the geometries. In this case the entire cut segment or groove segment 70 respectively, which is formed from a continuous groove 6 or the continuous cut 6 respectively and part of the outer face 74, is shown. The reference sign 75 in this case designates the angle width of the stand face and the reference sign 76 the opening angle of the groove 6.

### LIST OF REFERENCES

1 container
2 base portion
4 stand feet
4a outer wall
6 grooves
12 aperture portion
14 main body
18 injection point
20, 20a to 20g stand portions
22 thread
24 support ring
26 cylindrical portion in the base
32 circumferential region
42 first portion
44 second portion
45, 46, 48 curved portions
52 portion extending in a straight line
54, 56, 58 portions extending in a curved line
62 groove bottom
63 stand face
64 wall portion
65 distance between two stand portions
70 groove segment
74 part of the outer face
75 angle width of the stand face
76 opening angle of the groove 6
L longitudinal direction
R radial direction
H height of the base
H2 difference in height
b opening angle
P1, P2 points defining the angle
D1 distance between the stand portions
D2 width of the groove bottom
a1 to a7 angle
d angle
c1 angle formed by the groove
AA line
Z axis of rotation
K1 radius of curvature
DA external diameter
DS diameter of the stand circle
R1 radius of curvature
M centre line
T tangent

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A plastics material container, in particular for beverages, with an aperture by way of which a liquid is capable of being removed from the container, with a main body adjoining this aperture in a longitudinal direction and a base portion adjoining this main body in this longitudinal direction, wherein the base portion has at least three stand feet, wherein external surfaces of these stand feet in each case form a stand portion of the plastics material container extending in sections in the form of an annular segment over a pre-set circumferential angle and wherein at least three grooves are formed between these stand feet, wherein these grooves extend at least also in a radial direction of the plastics material container which is at a right angle to the longitudinal direction, wherein these grooves have in each case a groove bottom which extends at least also in the radial direction as well as a wall portion which extends at least also from this groove bottom to a stand portion of a stand foot adjacent to this groove bottom, wherein a sum of these circumferential angles is greater than 180°.

2. The plastics material container according to claim 1, wherein at least one groove starting from the groove bottom thereof has an opening angle which is less than 45.

3. The plastics material container according to claim 1, wherein the stand portions in the form of an annular segment span a stand plane of the container which is at a right angle to the longitudinal direction of the container.

4. The plastics material container according to claim 3, wherein at least one partial wall portion extends at least in sections at an angle which is more than 45°, with respect to the stand plane.

5. The plastics material container according to claim 1, wherein the container has between 3 and 12 stand feet.

6. The plastics material container according to claim 1, wherein a ratio between an external diameter of the plastics material container and a diameter of the stand circle is between 0.5 and 0.99.

7. The plastics material container according to claim 1, wherein at least one wall portion extends in a straight line at least in sections in at least one pre-set direction.

8. The plastics material container according to claim 6, wherein this wall portion extends in a straight line at least in sections in two pre-set directions at a right angle to each other.

9. The plastics material container according to claim 1, wherein the base portion has, at least in sections, a first dome-like structure extending in the direction of a centre of the base portion.

10. The plastics material container according to claim 1, wherein the centre of the base portion is arranged lower in the longitudinal direction of the plastics material container than a further portion (58) of the base portion.

11. The plastics material container according to claim 1, wherein the base portion has an injection point in its centre and at least one groove bottom extends as far as this injection point or is at a distance of less than 5 mm from this injection point.

12. The plastics material container according to claim 1, wherein at least one groove also extends in a circumferential portion of the base portion.

13. A blow mould for producing a plastics material container, wherein the blow mould forms a cavity inside which a plastics material pre-form is capable of being expanded against an inner wall of the blow mould by being acted upon with a flowable medium, wherein the blow mould has a base element which is suitable for producing a base portion of the container, wherein the base portion has at least three stand feet (4), wherein external surfaces of these stand feet in each case form a stand portion of the plastics material container extending in sections in the form of an annular segment over a pre-set circumferential angle and wherein at least three grooves are formed between these stand feet, wherein these grooves extend at least also in a radial direction of the plastics material container which is at a right angle to the longitudinal direction, wherein these grooves have in each case a groove bottom which extends at least also in the radial direction as well as a wall portion which extends at least also from this groove bottom to a stand portion of a stand foot adjacent to this groove bottom, and wherein a sum of these circumferential angles is greater than 180°.
